(19) United States
(12) Patent Application Publication
(10) Pub. No.: US 2009/0327073 A1
(43) Pub. Date: Dec. 31, 2009

(54) INTELLIGENT ADVERTISING DISPLAY

(75) Inventors: LI LI, ISSAQUAH, WA (US); YI CHEN, REDMOND, WA (US); ROHAN SHETTY, BELLEVUE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/163,644

(22) Filed: Jun. 27, 2008

(51) Int. Cl. G06Q 30/00

(52) U.S. Cl. 705/14.49

(57) ABSTRACT

Computer-readable media, systems, and methods for intelligent advertisement display are provided. The intelligent advertisement display comprises a photography device configured to capture one or more images of one or more persons, and electronic display configured to display information to one or more users, a content module configured to store advertising data received from one or more advertisers, one or more location directories and one or more images of one or more persons taken by the photography device. The intelligent advertisement display further comprises a directory module configured to access and display the one or more location directories, receive user inputs and display advertising data from content module associated with the one or more user inputs. A photography module is configured to receive the one or more and associate the photographs with one or more advertisements from the content module.

### SUMMARY

Embodiments of the present invention relate to computer-readable media, systems, and methods for intelligent advertisement display. The intelligent advertisement display comprises a photography device configured to capture one or more images of one or more persons and electronic display configured to display information to one or more users. The intelligent advertisement display further comprises a content module configured to store advertising data received from one or more advertisers, one or more location directories and one or more images of one or more persons taken by the photography device. The intelligent advertisement display further comprises a directory module configured to access and display the one or more location directories from content module, receive user inputs and display advertising data from content module associated with the one or more user inputs. A photography module is configured to receive the one or more images taken by the one or more imaging devices and associate the photographs with one or more advertisements from the content module.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing system environment suitable for use in implementing the present invention;

FIG. 2 is a block diagram illustrating an exemplary system for intelligent advertisement display, in accordance with an embodiment of the present invention;

FIG. 3 is a block diagram illustrating an exemplary system for intelligent advertisement display in accordance with an embodiment of the present invention;

FIG. 4 is a block diagram illustrating an exemplary content module in accordance with an embodiment of the present invention;

FIG. 5 is a block diagram illustrating an exemplary directory module in accordance with an embodiment of the present invention;

FIG. 6 is a block diagram illustrating an exemplary photo module in accordance with an embodiment of the present invention;

FIG. 7 is a block diagram illustrating an exemplary reporting module in accordance with an embodiment of the present invention;

FIG. 8 is a flow diagram illustrating an exemplary method for displaying advertisements associated with a search query of a location utilizing the advertising engine and display in accordance with an embodiment of the present invention;

FIG. 9 is a flow diagram illustrating a method for displaying advertisements associated with a selected location from a map utilizing the advertising engine and display in accordance with an embodiment of the present invention;

FIG. 10 is a flow diagram illustrating a method for associating and displaying photographs and advertisements utilizing the advertising engine and display in accordance with an embodiment of the present invention;

FIG. 11A is a flow diagram illustrating a method for calculating the number of viewers of a video advertisement in accordance with an embodiment of the present invention;

FIG. 11B is a flow diagram illustrating a method for calculating and storing the average number of viewers of a video advertisement in accordance with an embodiment of the present invention;

FIG. 12 is an interactive graphical display of a keyword search query of a location directory and associated advertisements in accordance with an embodiment of the present invention;

FIG. 13 is an interactive graphical display of a magnified view of a selected location from a location directory and associated advertisements in accordance with an embodiment of the present invention;

FIG. 14 is an interactive graphical display of a photograph taken by the intelligent advertising display and associated advertisements in accordance with an embodiment of the present invention; and

FIG. 15 is an interactive graphical display of a game utilizing a photograph taken by the intelligent advertising display in accordance with an embodiment of the present invention.

### DETAILED DESCRIPTION

The subject matter of the present invention is described with specificity herein to meet statutory requirements. However, the description itself is not intended to limit the scope of this patent. Rather, the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

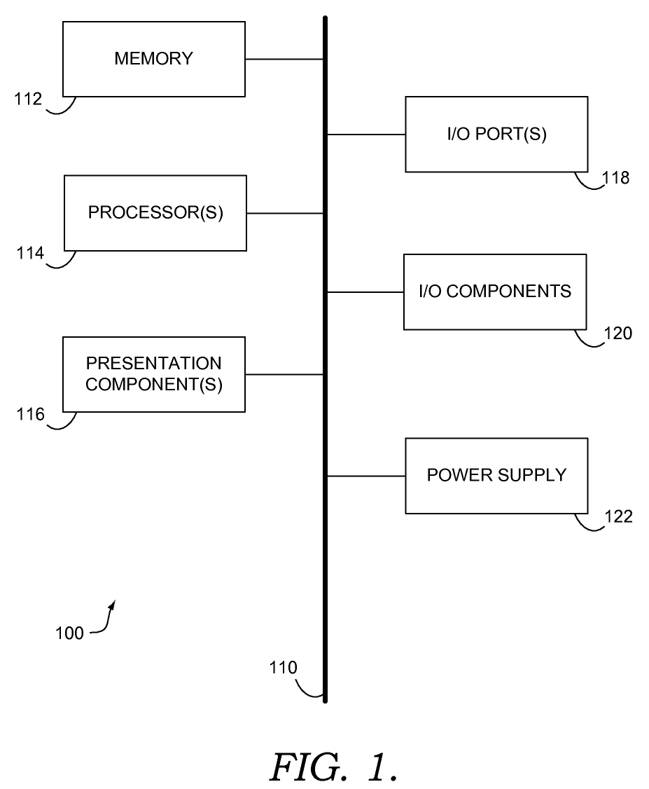

Referring to the drawing figures in general and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the present invention may be described in the general context of computer code or machine-usable instructions, including computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network. In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

Computing device 100 includes a bus 110 that directly or indirectly couples the following elements: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Thus, it should be noted that the diagram of FIG. 1 is merely illustrative of an exemplary computing device that may be used in connection with one or more embodiments of the present invention. Distinction is not made between such categories as “workstation,” “server,” “laptop,” “hand held device,” etc., as all are contemplated within the scope of FIG. 1 and reference to the term “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer storage media in the form of volatile and/or nonvolatile memory. The memory may be removable, nonremovable, or a combination thereof. Exemplary hardware devices include solid state memory, hard drives, optical disc drives, and the like. Computing device 100 includes one or more processors that read from various entities such as memory 112 or I/O components 120. Presentation component(s) 116 present data indications to a user or other device. Exemplary presentation components include a display device, speaker, printing component, vibrating component, and the like.

I/O ports 118 allow computing device 100 to be logically coupled to other devices including I/O components 120, some of which may be built in. Illustrative components include a microphone, joystick, game pad, satellite dish, scanner, printer, wireless device, etc.

Embodiments of the present invention relate to an integrated user interactive shopping mall directory and photography application utilizing an intelligent advertising display and camera. The intelligent advertising display allows shopping center management and shopping center stores (advertisers) to dynamically upload their latest information such as events, sales, location information and coupons. The photography module of the intelligent advertising display offers a selection of themes and styles for shoppers to use as backgrounds for photographs from popular travel destinations, fashion and trends, news events and the like. The photographs taken may be uploaded by a user to a web portal, social network account, e-mail account, or sent by text message.

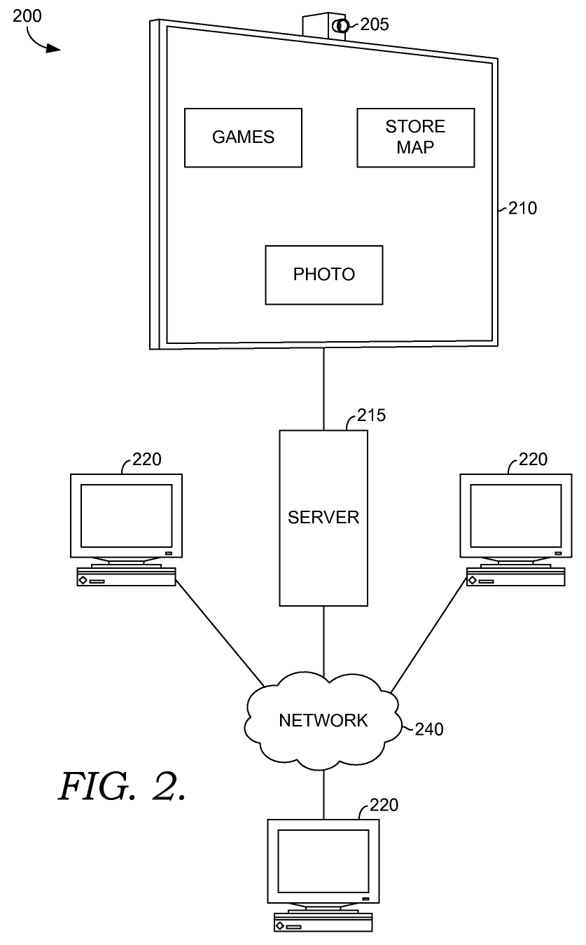

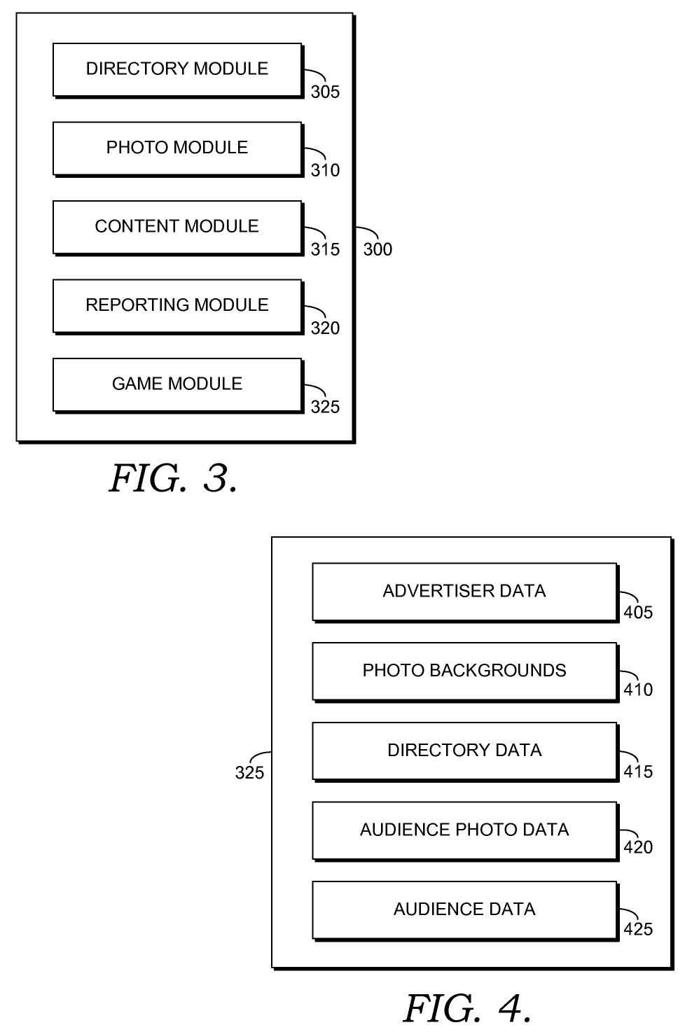

Intelligent advertising display comprises visual display unit 200 of FIG. 2 and advertising engine 300 of FIG. 3 discussed in more detail below. Electronic visual display unit 200, such as an electronic or computer kiosk comprises a photography device 205, display 210, computing device 215, advertiser computing devices 220 and network 240. Photography device 205 is configured to monitor a display environment and to receive data from an activity in the display environment. In various embodiments, by way of example, photography device 205 may be a single camera, multiple cameras and may take still or moving pictures. For instance, without limitation, the photography device 205 is configured to operate in various operating environments without the need for specially controlled illumination or special targets. In these embodiments, the single camera, operating in a display environment with typical lighting, can select and focus on a target portion of the audience viewing or interacting with display unit 210 using a region of attention applied to various activities. Thus, in these various embodiments, the camera is not distracted by constant motion within the display environment and is capable of ignoring certain environmental conditions. Further, in these various embodiments, perfect lighting is unnecessary because photography device 205 may be configured to adapt to various lighting schemes and still receive data from an activity in the display environment.

Display 210 is configured for displaying a information related to intelligent advertising display, including, but not limited to a location directory, photographs, advertisements, games, user options and the like. In one embodiment, information is displayed to users, such as shopping consumers, at a shopping mall or similar location. The display 210 is an interactive display unit that may be interacted with by users utilizing a touch screen, mouse, keyboard, voice recognition and the like. Display 210 may be any type of electronic display, including, but not limited to a CRT, LCD, plasma display, projection display, touch screens and the like.

Computing device 215 may be any variety of computing devices, such as computing device 100 of FIG. 1. Advertising engine 300 of FIG. 3, discussed more below, may reside on computing device 215. Advertiser devices 225 allow advertisers to submit data describing products or services provided by the advertisers via network 240 to advertising engine 300 of FIG. 3 residing on computing device 215. The network 240 may include, without limitation, one or more local area networks (LANs) and/or wide area networks (WANs). Such networking environments are commonplace in offices, enterprise-wide computer networks, intranets and the Internet.

Advertisers 225 may be entities interested in placing content into a location directory, photographs and the like for the purpose of advertising. Further, advertisers 225 may specify locations for placement of the content such as in a location directory, photograph and the like. For example, an advertiser promoting a children's store may specify when the advertisement is displayed (e.g., if a children's background is chosen for a photograph, a keyword search query is for a children's store or a children's store is selected from the location directory by a user.) In one embodiment, the user's advertisements may be displayed utilizing an online auction where the user's advertisement is displayed if they have entered a winning offer of bid.

For example, advertisers 225 may submit advertising information, such as advertisements, placement location, and coupons for display utilizing advertising engine 300 of FIG. 3 through a web portal. This allows for a centralized advertisement platform where the plurality of advertisers can submit data describing the products or services provided by the advertisers. Advertising information submitted by advertisers 225 may be stored in content module 315 of FIG. 3. Advertisers 225 are provided with easy access to content module 315 of FIG. 3 via network 240 without having to maintain any additional expensive software or devices. Advertiser information submitted is stored in advertiser data 405 of FIG. 4 of content module 315.

Advertiser database 405 is configured to store information related to advertising. In various embodiments, such information may include, without limitation, advertisements, advertisement locations, bidding information, coupons, video advertisements, video advertisement length, impression periods and other information capable of electronic display. In various embodiments, advertiser database 405 is configured such that it may be accessed and searched. In one embodiment, advertiser database 405 may be searched and accessed by the modules of advertising engine 300 discussed in more detail below.

Turning now to FIG. 3, a block diagram is provided illustrating an exemplary advertising engine 300 for advertisement display and advertisement audience calculation. Advertising engine 300 may reside on any type of computing device, such as computing device 215 described with reference to FIG. 2, and includes a directory module 305, photo module 310, content module 315, reporting module 320 and game module 325. It will be appreciated that the modules may be integrated with one another or may function separately as stand-alone applications.

Content module 315 is a central content management system or database configured for receiving and transmitting a variety of data for use with electronic visual display unit 200 of FIG. 2. With reference to FIG. 4, content module 315 comprises advertiser data 405, photo background data 410, directory data 415, photo data 420 and audience data 425. Advertiser database 405 is configured to store information related to advertising. In various embodiments, such information may include, without limitation, advertisements, advertisement locations, bidding information, coupons, video advertisements, video advertisement length, impression periods and other information capable of electronic display. In various embodiments, advertiser database 405 is configured such that it may be accessed and searched. In one embodiment, advertiser database 405 may be searched and accessed by the modules of advertising engine 300 discussed in more detail below. Advertiser data 405 may be utilized by a variety of modules of the advertising engine 300.

Photo background data 410 may include a variety of backgrounds such as tourist places of interests, movies, entertainment locations, children's backgrounds, world event backgrounds, seasonal backgrounds and general backgrounds and picture sizes. These backgrounds may be utilized by a variety of modules including photo module 310 discussed in more detail below. It will be appreciated that the photograph backgrounds and picture sizes may be updated regularly or periodically by a content editor.

Directory data 415 may include a variety of information related to a location, such as a shopping mall, airport, other transportation venue or other venue having a plurality of physical shopping and/or purchasing destinations. This information may include location maps, store locations, hours, facility information and the like. Directory data may be utilized by a variety of modules including directory module 305 described in more detail below. It will be appreciated that the directory data may be updated on a regular or periodic basis by a content editor, such as shopping mall management, as tenants may leave or join the shopping location or the configuration of stores may change. In one embodiment, content editors would access advertising engine 300 via a network much like advertisers 225 of FIG. 2.

Photo data 420 may include a variety of information related to photographs taken by photography device 205 of FIG. 2. Photo data may include photos of users, audiences and associated information. Photo data may be utilized by a variety of modules including photo module 310 and reporting module 320 described in more detail below.

Audience data 425 may include a variety of information related to the number of views of a video advertisement. Audience data 425 may include calculated number of views, calculated number of average viewers and related information reported by reporting module 320 as discussed below in more detail.

Content module 315 is configured to be searchable so that modules can search for and display content. It will be understood and appreciated that the information stored in content module 315 may be configurable and may include various information related intelligent advertising display. The content and/or volume of such information are not intended to limit the scope of embodiments of the present invention in any way. Further, though illustrated as a single, independent component, content module 315 may, in fact, be a plurality of databases, for instance, a database cluster, portions of which may reside on computing device associated with advertising engine 300, or another computing device or combinations thereof.

Directory module 305 is configured to display directory information and related advertisements to users. Directory module 305 provides an interactive location directory, such as a shopping mall directory, that allows users to interact with the map and search stores by name, category and location. Directory module comprises a map component 505, user input receiving component 510, accessing component 515, displaying component 520, output component 525 and reporting component 530.

Map component 505 accesses and displays maps of a location, such as a shopping mall. Map component 505 accesses this information from directory data 415 of FIG. 415. The maps of the location and related information are displayed to users on display 210 of electronic visual display unit 200. This allows shoppers to be able to interact with the map and directory unlike static paper print mall directories. Furthermore, a user may interact with the map of the location displayed by map component 505.

User input component 510 is configured to recognize user gestures in the display environment. In various embodiments, by way of example, user input component 510 is capable of interpreting movements of a member of a display environment audience and using the movement interpretations to allow the audience member to interact with advertising engine 300. For example, without limitation, user input component 510 may measure what one of ordinary skill in the art would understand as a mouse motion. The mouse motion would function similar to any type of pointer movement typically associated with a computing device, such as computing device 100 described with reference to FIG. 1.

In various embodiments, without limitation, to determine a mouse motion, user input component 510 maps a region of largest motion in a display environment and applies a region of attention to a location in the display environment containing the motion. In this embodiment, the region of attention ensures that user input component 510 is not distracted by the other motions in the display environment. In various embodiments, a member of the audience, or user, would interact with user input component 510 by approaching and pointing toward display 210 of FIG. 2. Information presented on display 210 will be adjusted according to the gestures of the user identified by user input component 510.

In various other embodiments, user input component 510 is capable of interpreting what one of ordinary skill in the art would understand as mouse click. The mouse click would function similar to any type of click typically associated with a computing device, such as computing device 100 described with reference to FIG. 1. In various embodiments, without limitation to determine a mouse click, user input component 510 considers a sequence of recent user motions in the region of attention. By way of example, the user may indicate a mouse click by wiggling a finger. In this example, user input component 510 considers the recent user motions such as the average flow magnitude and distance traveled in the image. If the flow magnitude is large but the distance traveled is small, user input component 510 interprets a mouse click.

Again, intelligent advertising engine 300 uses the gesture information from user input component 510 and information presented on display 210 will be adjusted accordingly. For example, using mouse motion and mouse click gestures, a user can interact with intelligent advertising engine 300. For example, user may select a portion of the map displayed by map component, may highlight stores the user is interested in by selecting the store type from a drop down menu or by entering other input.

Accessing component 515 accesses information related to the user input upon receiving user input from user input component 510. For example, if user has selected a store type from a drop-down menu, accessing component 515 accesses directory data 415 to determine the stores that satisfy the type and advertiser data 405 to determine if any advertisements are related to the user input. For example, advertiser data 405 may include advertisements and coupons related to one or more shoe stores if a user selects “shoes” as a store type. In another embodiment, if the user selects a particular store location, advertisements and coupons for the particular store may be accessed from advertiser data 405.

Displaying component 520 displays highlights and advertisements in response to user inputs on display 210. The advertisements and highlights are displayed in response to information accessed by accessing component 515 from advertiser data 405 in response to user inputs received.

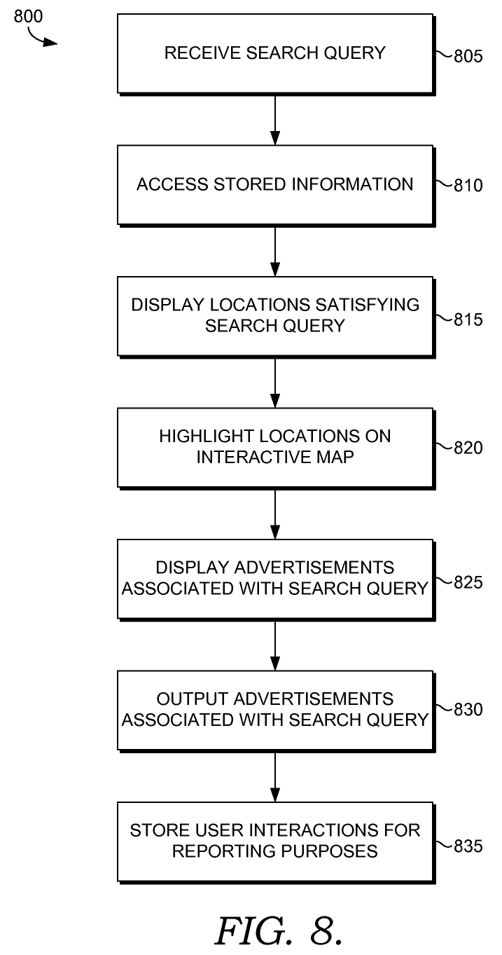

Referring to FIG. 8, a method 800 for displaying advertisements on an electronic visual display unit is shown. Advertisements associated with a search query input with by a user are displayed. At step 805, a search query is received from a user interaction with display 210 of FIG. 2. For example, a user may select a store or type of store from a drop down menu of an interactive store directory. At step 810, stored information is accessed. For example, advertiser data 405 and directory data 415 of FIG. 4 may be accessed to determine what stores satisfy the user's input and if there are any related advertisements that should be displayed.

At step 815, the locations satisfying the search query are displayed and at step 820 the locations are highlighted on the interactive store directory. At step 825, any advertisements that have been determined to be associated with the search query are displayed. For example, any advertisements that have been entered by an advertiser and stored in advertising data 405 of FIG. 4 related to shoe stores may be displayed on the or next to the interactive store directory.

At step 830, the advertisements, such as coupons, may be output. For example, a printer may be associated with the electronic visual display unit 200 of FIG. 2 allowing a user to print out coupons to utilize at the stores. Alternatively, the user may be able to electronically transmit the coupons to the user's e-mail account, social network site or text the coupons to the user's phone for use at the stores. At step 835, the user interactions with the electronic visual display unit 200 are stored for reporting the information to advertisers and content editors.

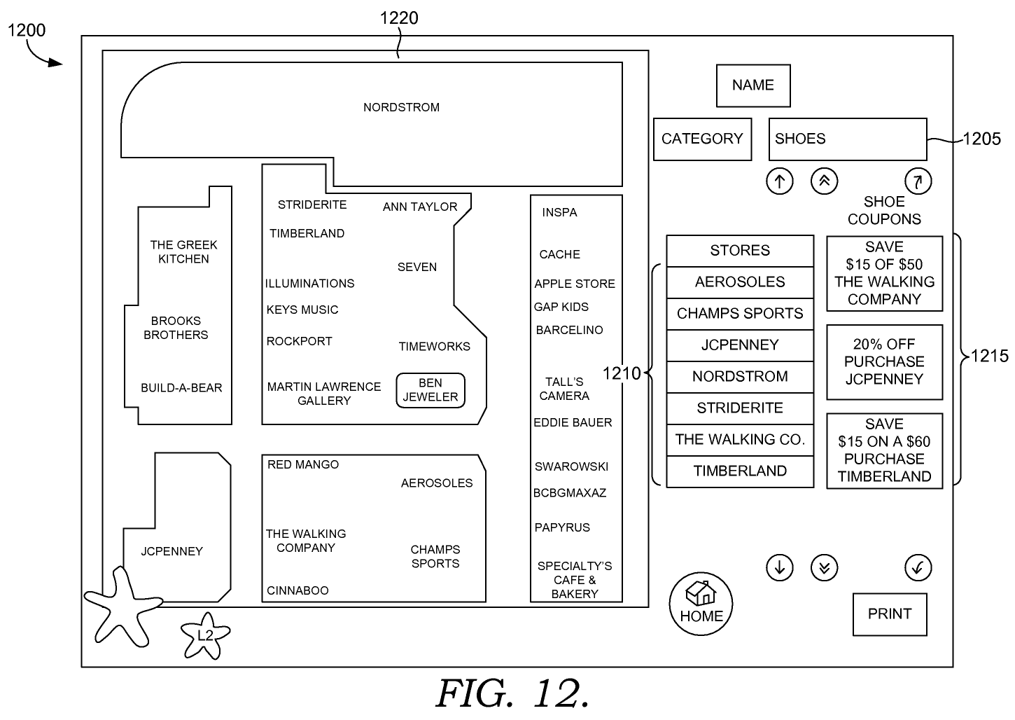

With reference to FIG. 12, an example of receiving user inputs and displaying advertisements in response to user inputs is shown. FIG. 12 is a graphical user display 1200 displaying store directory 1220 of a shopping location. Map component 505 displays an interactive store directory 1220. The user highlights that she is interested in shoe stores selecting “shoes” 1205 from a drop down menu to receive more information for shoe stores. The user inputs are received by user input component 510. In response to the user's selection, accessing component 515 accesses the appropriate stores and any related advertising information. Displaying component 520 displays shoe stores 1210 for the location and may also highlight them on the store directory 1220. In addition, displaying component 520 displays the associated advertisements 1215 accessed from advertising data 405.

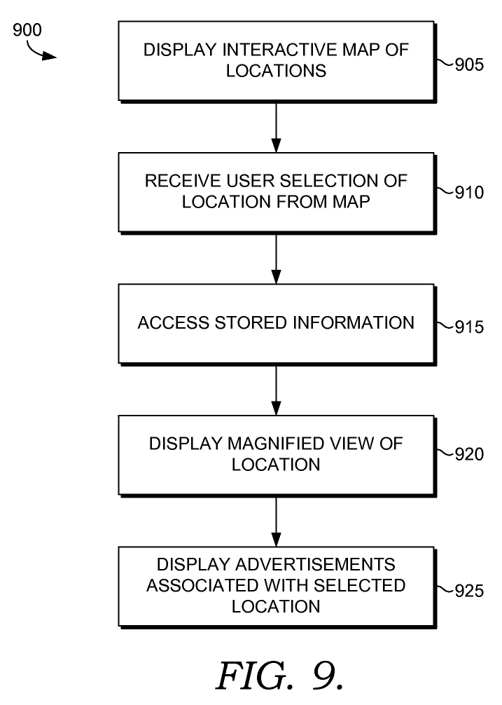

Referring to FIG. 9, a method 900 for displaying advertisement on an electronic visual display unit is shown. Advertisements associated with a user's selection of a location on an interactive shopping directory are displayed. At step 905, an interactive shopping directory is displayed. At step 910, the selection of a user of a location from a store directory is received from a user interaction with display 210 of FIG. 2. For example, a user may select of touch a location on the interactive map of a store they are interested in. At step 915, stored information is accessed. For example, advertiser data 405 and directory data 415 of FIG. 4 may be accessed to access information regarding the selected location and if there are any related advertisements that should be displayed.

At step 920 a magnified view of the location selected is displayed on the interactive store directory. At step 925, any advertisements that have been determined to be associated with the search query are displayed. For example, any advertisements that have been entered by an advertiser and stored in advertising data 405 of FIG. 4 for the selected store may be displayed on the or next to the interactive store directory.

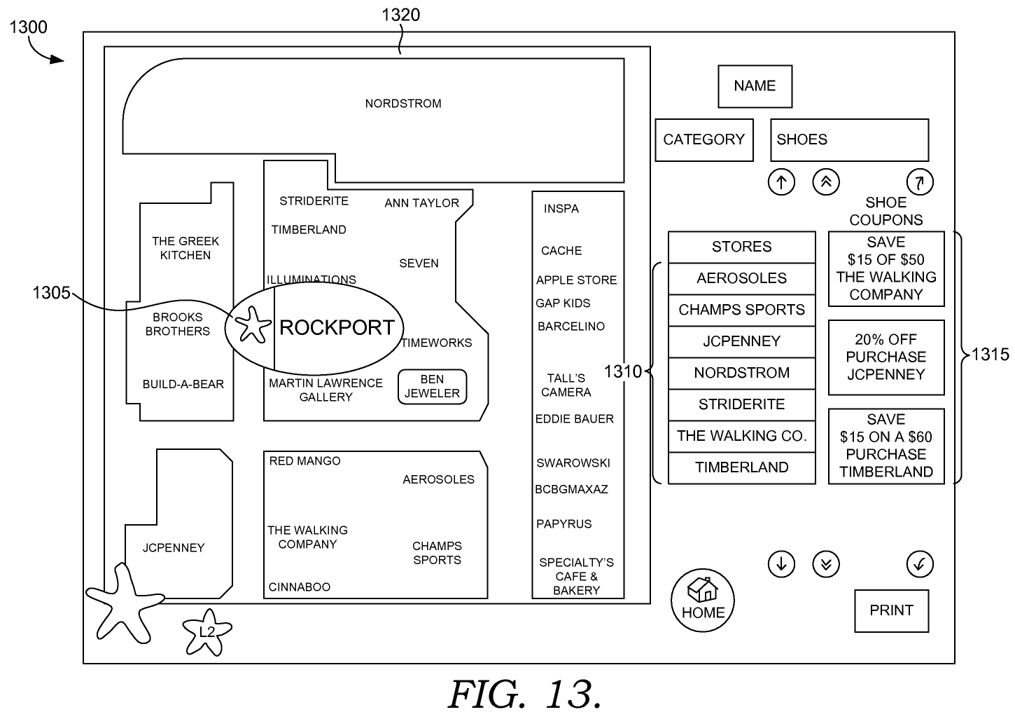

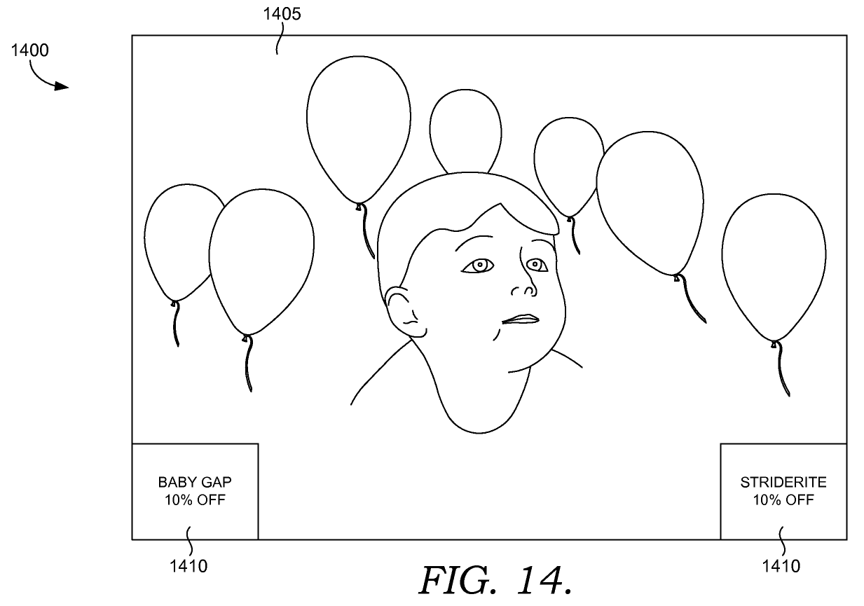

With reference to FIG. 13, an example of receiving user selection from an interactive store directory and displaying advertisements in response to user inputs is shown. FIG. 13 is a graphical user display 1300 displaying store directory 1320 of a shopping location. Map component 505 displays an interactive store directory 1320. The user selects a store that she is interested in from the interactive store directory 1320. For example, the user touches “Rockport.” The user input is received by user input component 510. In response to the user's selection, accessing component 515 any related advertising information to the selected store. Displaying component 520 displays a magnified and may also highlight them on the store directory 1320. In addition, displaying component 520 displays a magnified view 1305, related stores 1310 and any associated advertisements 1315. The user may be able to zoom in and out to see more details of store directory map 1320 from graphical user interface 1300.

Output component 525 allows a user to print advertisements, such as coupons or deals offered. Alternatively, output component may allow the user to electronically transmit these offers to an e-mail account, text message the offers to the user's cell phone and the like. Reporting component 530 stores information regarding this information may be stored in content module 315 and may be communicated to interested advertisers to see how many people used the map, number of times the advertiser's advertisement was displayed and average time a user utilized a map.

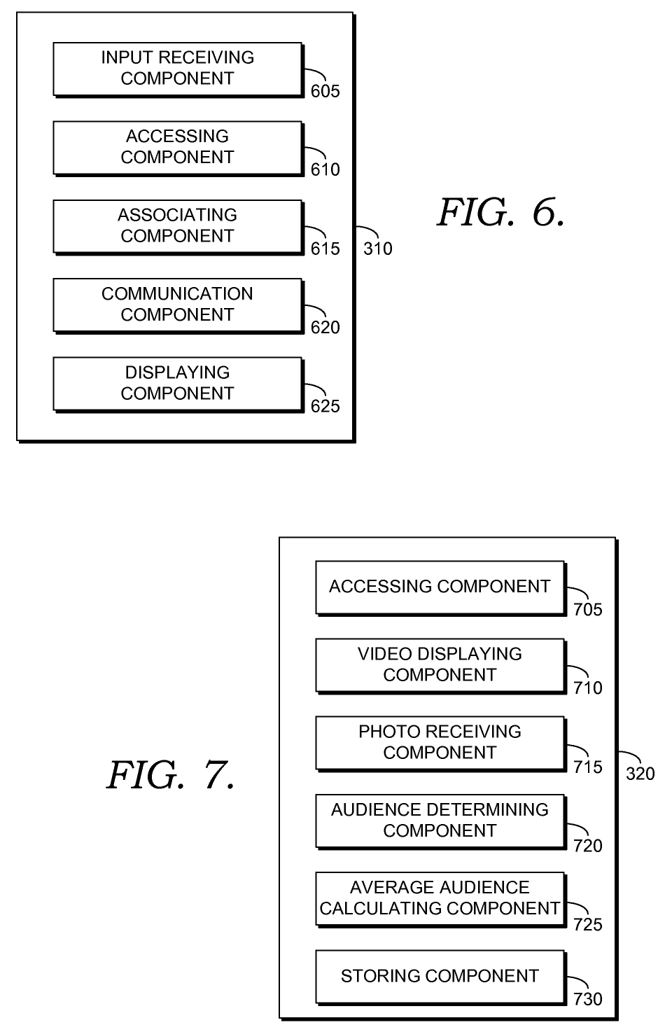

Referring next to FIG. 6, photo module 310 is configured to receive photographs of users and associate one or more advertisements with the photographs. Photo module comprises an input receive component 605, an accessing component 610, an associating component 615, a communication component 620 and a displaying component 625. Photo module 310 provides a gallery of various backgrounds, themes and styles for which users, such as shopping mall patrons, may select to have for their picture.

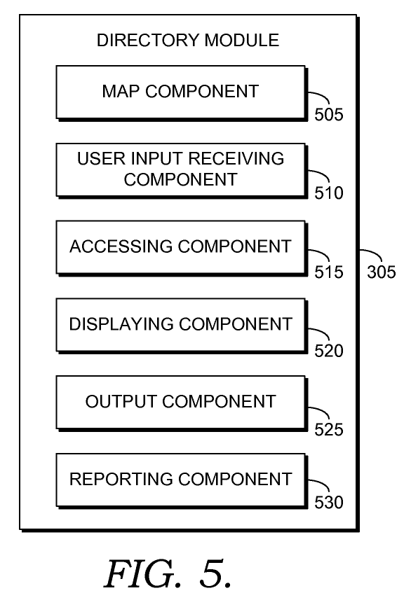

Input receiving component 605 receives user's selection of options for photograph, such as backgrounds, color, black and white, angle and distance. Input receiving component 605 also receives from photography device 205 a photograph of a user, such as a shopping mall patron once it has been taken. Photography device As described above with reference to input receiving component 505 of FIG. 5, a variety of inputs may be received by the user in a variety of ways. The user may be able to control the zoom, lightening and angle of the photography device 205 such a photograph is taken of an individual or a group of multiple individuals. An interactive user interface allows users to select a background, such as those stored in photo background data 410 of FIG. 4, size and borders of the photograph, and control functions of the photography device. It will be appreciated that the backgrounds, color, black and white, angle and distance of the photography device may be 205 automatically chosen by the system instead of providing the user the options to choose and/or control these functions.

Accessing component 610 accesses information related to the user input upon receiving user input from input receiving component 605. For example, if user has selected a particular background, size and/or border of a photograph accessing component 610 accesses advertiser data 405 to determine if any advertisements that are to be utilized with the user selections. For example, if the user has selected a background with an elegant red carpet event, advertisements, including coupons, related to cosmetic and shoe stores may be utilized with the user selections. Alternatively, if the user has selected a children's background or a seasonal background, advertisements pertaining to children's store may be relevant to the user selections. Associating component 615 is configured to associate one or more advertisements with a photograph taken by the photography device 210.

Communication component 620 is configured to allow a user to print photos taken. In one embodiment, the photos printed include advertisements, such as coupons or deals offered. Alternatively, output component may allow the user to electronically transmit the photographs to a web portal where the user may add comments, photo effects and post photos. In addition, a user may electronically transmit the photographs to an e-mail account, a social network account or via a text message to the user's cell phone and the like. In one embodiment, the photographs include advertisements, coupons or electronic links to advertisements and coupons.

Displaying component 625 photographs taken and associated advertisements in response to user inputs on display 210. The photographs and associated advertisements are displayed in response to information accessed by accessing component 610 from advertiser data 405 in response to user inputs received. By way of example, a display 1400 of a photograph 1405 of a child with a children's background is shown. Associated advertisements 1410 for children's stores are displayed with the photograph.

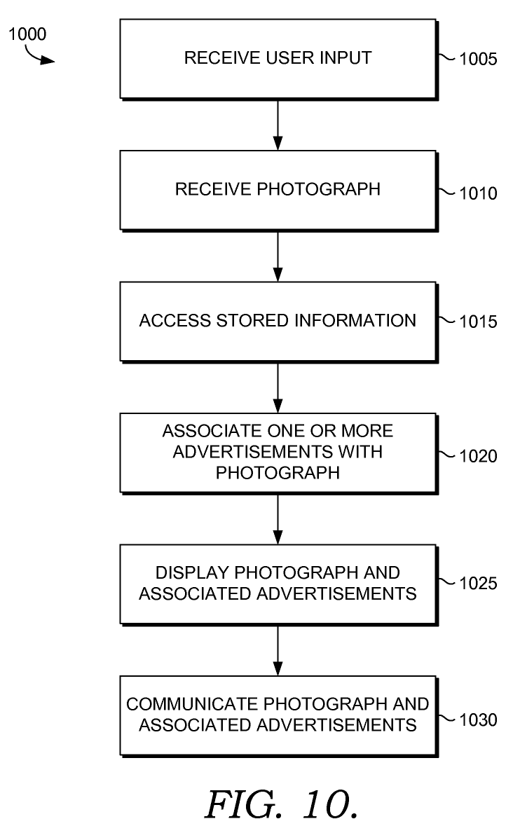

With reference to FIG. 10, a method 1000 for displaying photographs and associated advertisements utilizing an intelligent advertising display is shown. At step 1005 user input is received from a user interaction with display 210 of FIG. 2. The user input may be selection of a background for a photo, selection of photo size, adjustment to the camera lighting, zoom or angle. A photograph is taken based on the user input. At step 1010 the photograph of the one or more person is received by advertising engine 300 of FIG. 3. At step 1015, stored information is accessed. For example, advertiser data 405 may be accessed to determine if there are any related advertisements that should be displayed with the photograph. For example, certain backgrounds selected or size of photograph may cause certain advertisements or coupons for stores to be associated and displayed with the photograph at steps 1020 and 1025. The photograph and associated advertisement may be displayed on display 210. At step 830, the photograph and associated advertisements may be output or communicated. For example, a printer may be associated with the electronic visual display unit 200 of FIG. 2 allowing a user to print out the photographs. Alternatively, the user may be able to electronically transmit the photographs and associated advertisements to the user's e-mail account, social network site or text the photographs to the user's phone for use at the stores.

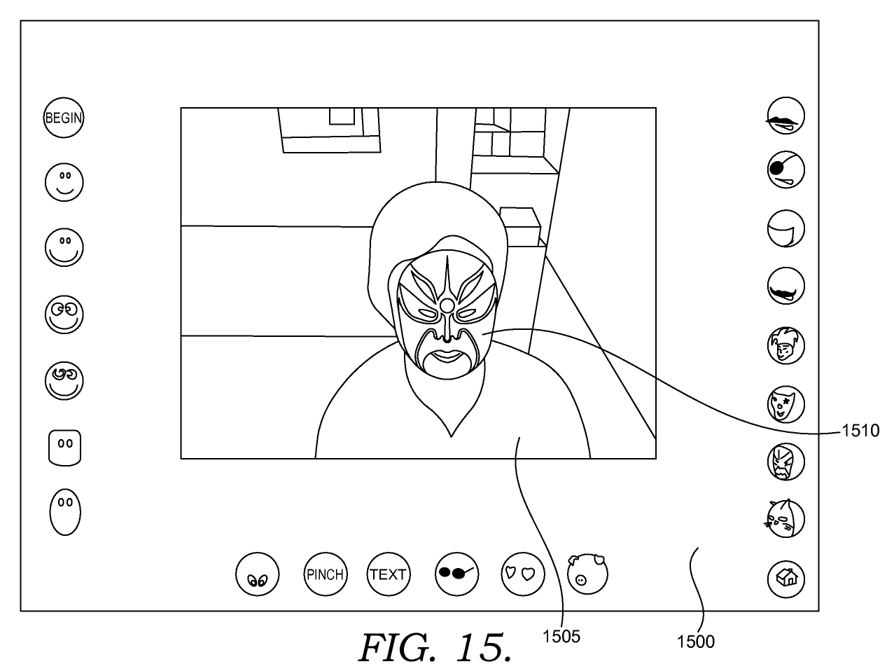

Referring again to FIG. 3, gaming module 325 is configured to allow a user, such as a shopper at a shopping mall, to interact with the intelligent advertising display. Gaming module allows a user to play games with the interactive advertising display by playing a game to engage the user and present the user with advertising. An exemplary game is shown in FIG. 15. An interactive user interface 1500 is displayed that allows a user to add embellishments to photographs taken by photography device 205 of FIG. 2. The user may add masks, features and embellishments 1510 to the photograph 1505.

Referring next to FIG. 7, reporting module 320 is configured to display a video advertisement and determine the number of viewers of the advertisement. Reporting module 320 allows for accurate reporting on audience statistics in real time and does not require individual face detection allowing the reporting module 320 to function efficiently. Reporting module 320 is able to provide accurate data such as average audience size when certain advertisements are displayed in certain locations, such as shopping malls, sports venues, transportations venues, amusement parks and the like. Although, reporting module 320 may be utilized in any variety of locations. For example, reporting module 320 may determine that an average 12 people watch a 30 seconds Starbucks advertisement in Seattle, while nationwide on average 7 peopled watched the same Starbucks ads.

Reporting module 320 comprises an accessing component 705, a video displaying component 710, a photo receiving component 715, an audience determining component 720, an average audience calculating component 725 and a storing component 730.

Accessing component 705 is configured to access an advertisement to be displayed on display 210 of FIG. 2, along with the time period that a photo should be taken and the impression effective period. It will be appreciated that the advertisement may be a static image, video advertisement, banner advertisement or the like. For example, for the photo time period, it may be specified that for a one (1) minute advertisement that a photo be taken at the start of the advertisement and every five (5) seconds thereafter until the video advertisement is finished playing. It will be appreciated that the photo time period may vary from advertisement to advertisement depending on the length of the advertisement and specifications of the advertiser. The impression effective time period refers to how long it will take a user to look at an advertisement and for the advertisement to leave an impression. For example,

Advertisement display component 710 is configured to display the advertisement on display 210 of FIG. 2. Photo receiving component 715 receives photos from specified time period. For example, for a 30 second video advertisement, an image of the audience viewing the advertisement while displayed may be taken when the advertisement begins and every five (5) seconds thereafter until the advertisement is finished. Photography device 205 of FIG. 2 is mounted on and integrated with display 210 such that it can capture images of an audience of persons viewing an advertisement displayed on display 210. Photography device 205 provides a high quality images that allows the number of faces in a picture to be counted.

Audience determining component 720 determines the number of faces per image or photograph received. The audience determining component 720 determines the number of faces per picture. In on embodiment, the audience determining component 720 does not require faces from one frame match faces detected in another frame (e.g., does not track individual users). In this embodiment, face tracking and recognition algorithms are not needed. The audience determining component 720 merely counts the number of faces in a picture using a face detection algorithm that does not require matching of faces from frame to frame.

Average audience calculating component 725 is configured to calculate the average audience or number of viewers of the advertisement displayed. In one embodiment, the number of faces in each picture are added and divided by the number of pictures received by audience determining component 720 to calculate the average number of viewers. In another embodiment, the average is calculated per impression period and not per frame or picture. For example, in this embodiment, the average number of viewers is calculated for an impression effective time period instead of per frame. For example, a 30 second advertisement, the audience may be measured every 5 seconds with a sliding impression-effective time period to measure average audience size. For example, with reference to Table 1, the impression effective time window is fifteen (15) seconds for a 30 second advertisement and the audience is measured every five (5) seconds. As can be seen from Table 1, an average is not taken until the video advertisement has been running for at least 15 seconds (Frame 4).

TABLE 1

| | | | Sliding |
|---|---|---|---|
| | | | Window |
| | | Face | Calculation of |
| Frame # | Time | Detected | Audience Size |
| 1 | 15:00:00 | 2 | |
| 2 | 15:00:05 | 5 | |
| 3 | 15:00:10 | 9 | |
| 4 | 15:00:15 | 12 | (2 + 5 + 9 + 12)/4 = 7 |
| 5 | 15:00:20 | 15 | (5 + 9 + 12 + 15)/4 = 10.25 |
| 6 | 15:00:30 | 13 | (12 + 15 + 13 + 13) = 13.25 |

Thus, the average number of views for the first 15 seconds (Frames 1, 2, 3, and 4 taken at :00, :05, :10 and :15 seconds after the video advertisement has started) is seven (7) viewers. The average number of viewers for the next impression effective time window is from :05 to :20 seconds after the video advertisement has started (Frames 2, 3, 4 and 5) and is 10.25 viewers.

The average number of viewers per impression effective time window is then calculated by adding together the averages of each impression effective time windows and dividing by the number of impression effective time windows. In this case the total number of viewers is 7+10.25+12.25+13.25=42.75. The total number of viewers is divided by the number of impression effective time windows: 42.75/4=10.69, which is an approximate average number of viewers of the advertisement of 11.

If a simple average per frame or picture is calculated, the resulting audience size would be less than 11 because even weights on each frame. While in another embodiment, the sliding impression effective window focuses on the middle part of the advertisement displayed providing a better indication of how many people are really engaged viewing the advertisement.

The average calculating component 725 provides advertisers the ability to specify their focus window. For example, an advertiser may specify that the 10-20 second period of a 30 second advertisement is the most important part that they want users to watch. The average calculating component can place more weight on the focus window to calculate an average number of viewers. A variety of heuristics produced by experiments and trials may also be applied to the average calculating component 725 can also use other heuristics produced by experiments and trials. The number of viewers per frame or pictures and average number of viewers may be stored in content module 315 by storing component 730.

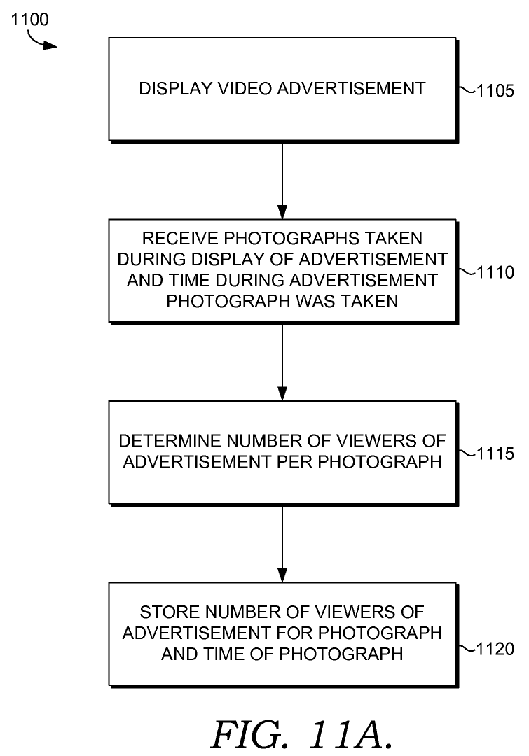

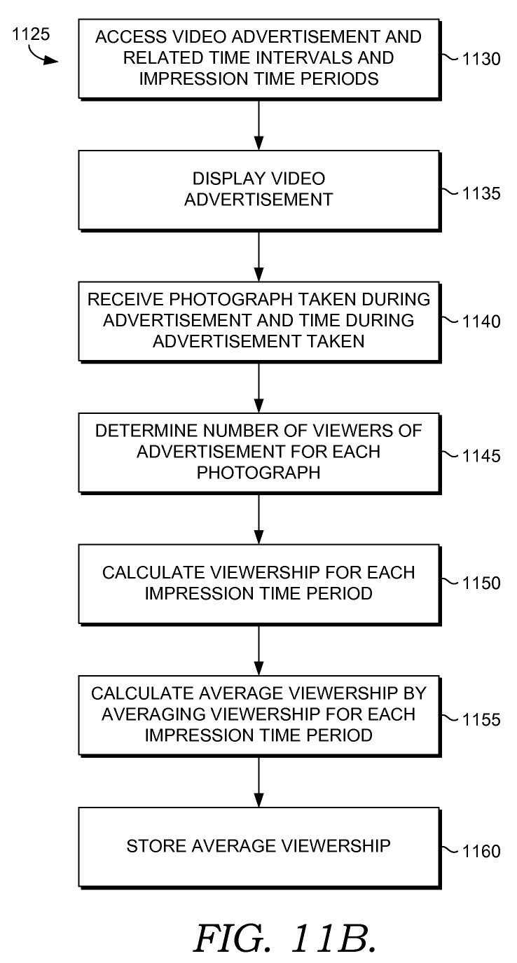

With reference to FIG. 11A, a computer-implemented method 1100 for determining and storing the number of viewers of an advertisement per frame or picture taken by photography device 205 is shown. At step 1105 an advertisement, such as a video advertisement, is displayed on a display 215. At step 1110, photographs or pictures taken during the display of the advertisement at specified intervals are received. At step 1115, the number of viewers of the advertisement per picture or photograph is determined. At step 1120, the number of viewers of the advertisement is stored in content module 315 of FIG. 3.

With reference to FIG. 11B, a method 1125 for calculating and storing an average number of viewers for an impression time period is shown. At step 1130, an advertisement to be displayed on display 210 of FIG. 2, related time intervals for images to be taken of a viewing audience and impression time periods are accessed from advertising data 405 of FIG. 4. At step 1135, the advertisement is displayed to viewers, such as pedestrians and shoppers, on display 210 of FIG. 2. At step 1140, the photographs taken at the specified intervals while the advertisement was displayed are received. At step 1145, the number of viewers of the advertisements for each photograph received is determined by counting the number of faces in the photograph. At step 1150, the average number of viewers per impression time period is determined. At step 1155, the average number of viewers is calculated by averaging the number of viewers for each impression time period. At step 1160, the average number of viewers that viewed the advertisement is stored, for example in content module 315 of FIG. 3. Identifying information such as location information (e.g., location of the display 210), identification of the advertisement displayed, time the advertisement was displayed, number of viewers at each time interval, average number of viewers per impression period and total average number of viewers of the advertisement may be stored or displayed. This information may be utilized by advertisers to accurately determine how effective broadcast advertising to a large audience and whether the money invested in the advertisement is provided the desired return. It will be appreciated that although reporting module is shown in FIG. 3 in conjunction with other modules, that it may be a stand-alone application.

It will be understood by those of ordinary skill in the art that other implementations may be possible and that embodiments hereof are not intended to be limited to any particular implementation method or process.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. An integrated computer system that comprises a directory module and a photography module for intelligent advertising display, the system comprising:
a content module configured to store advertising data received from one or more advertisers, one or more location directories and one or more images of one or more persons taken by one or more imaging devices;
a directory module configured to accesses and display the one or more location directories from content module, receive user inputs and display advertising data from content module associated with the one or more user inputs;
a photography module configured to receive the one or more images taken by the one or more imaging devices and associate the photographs with one or more advertisements from the content module.

2. The computer system of claim 1, further comprising:
a photography device configured to take images of one or more users.

3. The computer system of claim 2, further comprising:
an electronic display configured to display information to users.

4. The computer system of claim 3, wherein the one or more location directories and advertising data associated with one or more user inputs are displayed on the electronic display.

5. The computer system of claim 4, wherein the one or more images and advertisements associated with the one or more images are displayed on the electronic display.

6. The computer system of claim 5, wherein the one or more location directories comprises the location of one or more retail stores.

7. The computer system of claim 6, wherein the one or more advertisers may specify that one or more advertisements should be associated with the selection of a retail location or selection of a category of retail stores.

8. The computer system of claim 7, wherein the one or more advertisements comprise one of coupons and advertisements.

9. The computer system of claim 8, wherein the user inputs comprise a selection by the user of a retail location from the one or more location directories displayed.

10. The computer system of claim 9, wherein the advertising data displayed is associated with the selected retail location.

11. The computer system of claim 10, wherein the user inputs comprise selecting a category of retail stores.

12. The computer system of claim 11, wherein the advertising data displayed is associated with the category of retail stores selected.

13. The computer system of claim 12, wherein the photography module is configured to receive user inputs.

14. The computer system of claim 13, wherein the user inputs received by the photography module comprise one or more of selection of size of photograph, background of photograph, angle of the photography device and zoom of the photography device.

15. One or more computer readable media having instructions embodied thereon that, when executed, perform a method for calculating the number of persons viewing a displayed advertisement, the method comprising:
accessing an advertisement to be displayed;
displaying the advertisement to an audience on an electronic display;
utilizing an imaging device to capture one or more images of the audience using an imaging device while the advertisement is displayed;
receiving the one or more images captured;
determining the number of persons in each of the one or more images by counting the number of faces in the image; and
storing the number of persons in each of the one or more images as the number of persons viewing the advertisement.

16. The computer readable media of claim 15, further comprising:
accessing one or more time intervals at which images are to be captured of the audience while the image is displayed.
capturing the one or more images at the one or more time intervals;
determining the number of persons in each of the one or more images at each of the one or more time intervals by counting the number of faces in the image;
storing the number of persons in each of the one or more images at each of the one or more time intervals as the number of persons viewing the advertisement at each time interval.

17. The computer readable media of claim 16, further comprising:
accessing an impression effective period for the advertisement, wherein the impression effective period is the minimum amount of time a user should view the advertisement for the advertisement to leave an impression;
determining the average number of persons viewing the advertisement for each impression effective time period for the advertisement by averaging the number of faces in each of the one or more images for the impression effective time period; and
determining the average number of persons viewing the advertisement by averaging the number of persons for each impression effective time period.

18. The computer readable media of claim 17, wherein the imaging device is a camera.

19. The computer readable media of claim 18, wherein the advertisement is a video advertisement.

20. An integrated computerized system that comprises a directory module and a photography module for intelligent advertising display, the system comprising:
a photography device configured to capture one or more images of one or more persons;
an electronic display configured to display information to one or more users;
a content module configured to store advertising data received from one or more advertisers, one or more location directories and one or more images of one or more persons taken by the photography device;
a directory module configured to accesses and display the one or more location directories from content module, receive user inputs and display advertising data from content module associated with the one or more user inputs; and
a photography module configured to receive the one or more images taken by the one or more imaging devices and associate the photographs with one or more advertisements from the content module.
